(19) United States
(12) Patent Application Publication
(10) Pub. No.: US 2024/0002572 A1
(43) Pub. Date: Jan. 4, 2024

(54) SOL LIQUID, MIXED LIQUID, COATING FILM, METHOD OF PRODUCING SOL LIQUID, AND METHOD OF PRODUCING COATING FILM

(71) Applicant: CANON KABUSHIKI KAISHA, Tokyo (JP)

(72) Inventors: Haruka Takeuchi, Fukui (JP); Haruna Hatayama, Fukui (JP); Daichi Watanabe, Fukui (JP); Mitsunori Sugimoto, Ishikawa (JP)

(21) Appl. No.: 18/332,915

(22) Filed: Jun. 12, 2023

(30) Foreign Application Priority Data
Jun. 29, 2022 (JP) 2022-104842
Apr. 28, 2023 (JP) 2023-074623

(51) Int. Cl. C08G 6/00; C09D 161/02

(52) U.S. Cl. CPC C08G 6/00; C09D 161/02

(57) ABSTRACT

Provided is a sol liquid which is excellent in dispersion stability even when the sol liquid contains water, which can be mixed with an existing aqueous sol liquid at any ratio, and which can easily produce even a uniform composite inorganic oxide film with a satisfactory coating property. Specifically, provided is a sol liquid including a metal alkoxide condensate, an α-substituted β-diketone, and a water-soluble organic solvent, the sol liquid further including an inorganic acid and an organic acid.

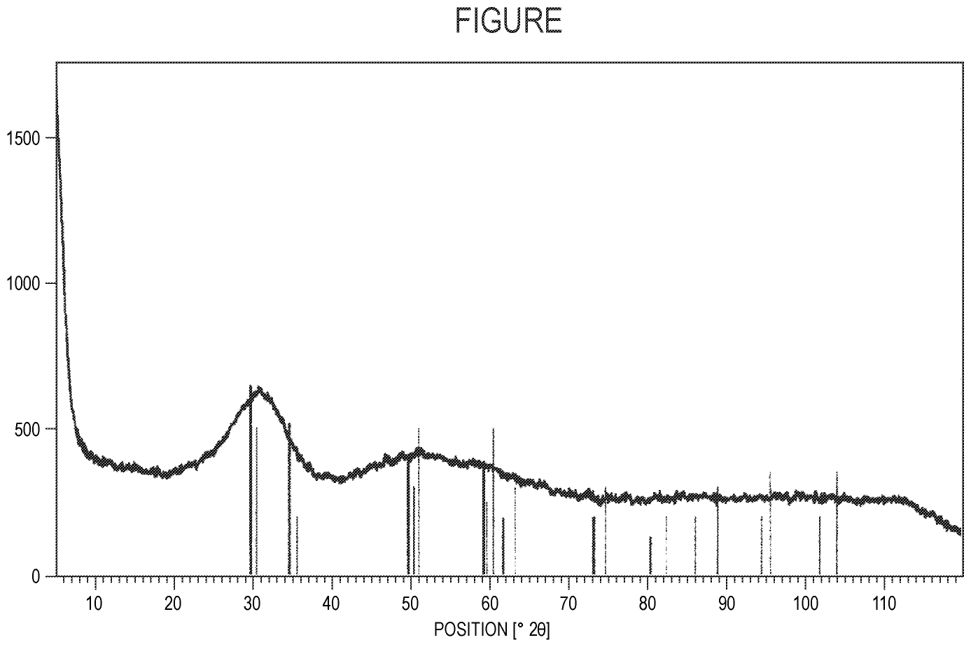

### BACKGROUND OF THE INVENTION

### Field of the Invention

The present invention relates to a sol liquid, a mixed liquid, a coating film, a method of producing a sol liquid, and a method of producing a coating film.

### Description of the Related Art

A metal oxide thin film is a functional material suitable for, for example, an optical film, an antireflection film, a photocatalyst, a transparent conductive film, or a surface protective film. In general, the metal oxide thin film is formed by a chemical vapor deposition method (CVD method), a physical vapor deposition method (PVD method), or a sol-gel method. In the sol-gel method, a colloid liquid is produced by hydrolysis with water and a polycondensation reaction using a metal alkoxide or a metal chloride as a raw material.

The sol-gel method using an organosol liquid containing an organic solvent as a main solvent is a method by which many kinds of metal oxide and composite metal oxide sols can be produced, and the produced sol liquid has an advantage in that, for example, coating is easily performed owing to high wettability of the organic solvent to a base material. In particular, for the purpose of forming a thin film, the sol-gel method has an advantage in that a uniform film can be easily formed. However, when the organosol liquid contains a large amount of water in the solvent, excessive deterioration of dispersibility or gelation is liable to occur through aggregation between condensates, and hence the sol-gel method has is a problem that long-term storage of organosol liquid in a stably dispersed state is difficult.

In recent years, the usage of forming a composite metal oxide film having a plurality of elements has been increasing, and a liquid obtained by mixing multielement inorganic particle slurry has been desired. In Japanese Patent Application Laid-Open No. 2011-073893, there is a description that, in an aqueous nanoparticle zirconia sol, a long-term durability of the dispersed state of the sol when mixed with a hydrophilic solvent can be improved by using glucose or sucrose as a dispersant. In addition, in Japanese Patent Application Laid-Open No. 2007-51053, there is a description that metal oxide nanoparticles can be stably dispersed in an organic solvent by using a surfactant as a dispersant. In addition, in Japanese Patent Application Laid-Open No. H10-259007, there is a description of a coating liquid for forming a thin film containing a metal alkoxide, a hydrolysate of a metal alkoxide, and a β-diketone.

However, the sol liquid of each of Japanese Patent Application Laid-Open No. 2011-073893 and Japanese Patent Application Laid-Open No. 2007-51053 has a risk in that the dispersant may remain even after baking. In Japanese Patent Application Laid-Open No. H10-259007, the dispersion stability deteriorates at the time of addition of water to the coating liquid, and hence there is a risk in that the coating property may deteriorate or a uniform coating film may be hardly obtained.

An object of the present invention is to provide a sol liquid, which is excellent in dispersion stability even when the sol liquid contains water, which can be mixed with an existing aqueous sol liquid at any ratio, and which can easily produce even a uniform composite inorganic oxide film with a good coating property. Further, another object of the present invention is to provide a mixed liquid and a coating film each using a sol liquid, a method of producing a sol liquid, and a method of producing a coating film.

### SUMMARY OF THE INVENTION

The inventors of the present invention have found that the above-mentioned objects can be achieved by applying a specific stabilizer and two kinds of acids to a particulate condensate obtained by condensation of a metal alkoxide in a sol liquid. Thus, the inventors have arrived at the present invention.

That is, a sol liquid of the present invention is a sol liquid including: a metal alkoxide condensate; an α-substituted β-diketone; and a water-soluble organic solvent, the sol liquid further including an inorganic acid and an organic acid.

Further features of the present invention will become apparent from the following description of exemplary embodiments with reference to the attached drawing.

### BRIEF DESCRIPTION OF THE DRAWINGS

FIGURE shows results of an X-ray diffraction (XRD) analysis of zirconium oxide powder obtained by sintering a sol liquid of Example 1 in an electric furnace at 300° C. for 2 hours.

### DESCRIPTION OF THE EMBODIMENTS

Embodiments of the present invention are described as follows, but the present invention is not limited to the following embodiments.

<Sol Liquid>

A sol liquid of the present invention is a sol liquid including: a metal alkoxide condensate; an α-substituted β-diketone; and a water-soluble organic solvent, and the sol liquid further includes an inorganic acid and an organic acid. The sol liquid of the present invention may also be referred to as “organosol liquid”. Various additives, such as a pH adjuster and a viscosity modifier, may be appropriately added to the sol liquid of the present invention.

The sol liquid of the present invention may be formed into a film with the sol liquid alone, or may be formed into a film as a mixed liquid with water or an aqueous sol liquid. The sol liquid of the present invention can be stably applied without occurrence of a reduction in dispersibility such as occurrence of cloudiness also when the sol liquid is used as a mixed liquid. In addition, when the sol liquid contains a plurality of metal elements, or when a mixed liquid obtained by mixing the sol liquid and an aqueous sol liquid contains a plurality of metal elements, a composite inorganic oxide film can be formed by using any of those liquids. For example, the following case may be given: the metal alkoxide condensate in the sol liquid contains one kind of metal element (first metal element) and the metal alkoxide condensate in the aqueous sol liquid to be mixed contains a second metal element different from the first metal element.

[1] Metal Alkoxide Condensate

### (a) Metal Alkoxide

A metal alkoxide to be used in the present invention is represented by the following formula (a):

M(OR)ₘOₙ (a)

in the formula (a), M represents a metal element of Group 3 to 15 of the periodic table, R represents a saturated or unsaturated hydrocarbon group, “m” represents an integer of 2 or more and 5 or less, and “n” represents 0 or 1.

Examples of the metal element M include aluminum, silicon, scandium, titanium, vanadium, manganese, iron, cobalt, zinc, gallium, germanium, yttrium, zirconium, niobium, molybdenum, indium, tin, antimony, lanthanum, tantalum, tungsten, and iridium. Preferred examples thereof include aluminum, silicon, titanium, vanadium, manganese, zinc, yttrium, zirconium, niobium, molybdenum, indium, tin, tantalum, and tungsten.

Examples of the metal alkoxide to be preferably used include tri-i-propoxyaluminum, tri-n-propoxyaluminum, tri-i-butoxyaluminum, tri-n-butoxy aluminum, tri-sec-butoxy aluminum, tetraethoxysilane, tetra-i-propoxysilane, tetra-n-propoxysilane, tetra-i-butoxysilane, tetra-n-butoxysilane, tetra-sec-butoxy silane, tetramethoxytitanium, tetraethoxytitanium, tetra-n-propoxytitanium, tetra-i-propoxytitanium, tetra-n-butoxytitanium, tetra-i-butoxytitanium, tetra-sec-butoxytitanium, vanadium-trimethoxide oxide, vanadium-triethoxide oxide, vanadium-tri-n-propoxide oxide, vanadium-tri-butoxide oxide, vanadium-tri-n-butoxide oxide, vanadium-tri-sec-butoxide oxide, di-i-propoxymanganese, diethoxyzinc, triethoxyyttrium, tri-i-propoxyyttrium, tetramethoxyzirconium, tetraethoxyzirconium, tetra-i-propoxyzirconium, tetra-n-propoxyzirconium, tetra-i-butoxyzirconium, tetra-n-butoxyzirconium, tetra-sec-butoxyzirconium, pentaethoxyniobium, penta-i-propoxyniobium, penta-n-propoxyniobium, penta-n-butoxyniobium, penta-i-butoxyniobium, penta-sec-butoxyniobium, pentaethoxymolybdenum, tri-i-propoxyindium, tetraethoxytin, tetra-i-propoxytin, tetra-n-butoxytin, pentamethoxytantalum, pentaethoxytantalum, penta-i-propoxytantalum, penta-n-propoxytantalum, penta-i-butoxytantalum, penta-n-butoxytantalum, penta-sec-butoxytantalum, and pentaethoxytungsten.

### (b) Condensate

A condensate of the metal alkoxide is obtained by hydrolysis of a metal alkoxide represented by the formula (a) in an organic solvent in the presence of water. One kind of the metal alkoxide represented by the formula (a) may be used in the formation, or a plurality of kinds thereof may be used.

The metal element content “a” [mass %] of the metal alkoxide condensate with respect to the total amount of the sol liquid preferably falls within 0.770≤a≤6.20, more preferably falls within 0.800≤a≤6.00, and still more preferably falls within 1.00≤a≤5.00.

### (c) Degree of Condensation of Condensate

The condensate is preferably an incomplete condensate in which the degree of progress of condensation has not reached 100%. The degree of condensation of the condensate in the sol liquid is preferably 25% or more and 70% or less, more preferably 30% or more and 60% or less. When the degree of condensation is 25% or more, sufficient film strength can be easily obtained. In addition, when the degree of condensation is 70% or less, gelation can be prevented in the state of a solution, and hence a film-forming property can be secured.

### (d) Particle Diameter of Condensate

The condensate of the metal alkoxide is particulate (hereinafter sometimes simply referred to as “particulate condensate”). The median diameter of the particulate condensate is preferably 1 nm or more and 100 nm or less, more preferably 1 nm or more and 50 nm or less, most preferably 2 nm or more and 20 nm or less. The median diameter may be determined by a dynamic light scattering method in the sol liquid. When the median diameter is 1 nm or more, the metal alkoxide has a moderate degree of condensation, and uneven distribution or a crack hardly occurs at the time of film formation, and hence a uniform film can be obtained. In addition, when the median diameter is 100 nm or less, dispersion stability is hardly reduced when the sol liquid is mixed with water or an aqueous sol, and hence transparency of the film after the film formation can be obtained.

A specific method of measuring the median diameter may be, for example, measurement which uses the scattering of laser light using NANOTRAC FLEX (manufactured by MicrotracBEL Corp., a 50% cumulative value in a volume distribution is adopted). For example, in a sol liquid containing a condensate of a zirconium alkoxide and containing 2-propanol as a main solvent, the median diameter may be determined in accordance with the following procedure. The produced sol liquid is adopted as a measurement sample as it is, and the particle diameter is measured 5 times under the measurement conditions of a particle refractive index of 2.21, a solvent refractive index of 1.38, and a measurement time of 30 seconds using NANOTRAC FLEX, and an average value thereof is adopted as the median diameter of the metal alkoxide condensate.

[2] α-Substituted β-Diketone

The α-substituted β-diketone acts as a stabilizer in subjecting a metal alkoxide to hydrolysis and condensation to synthesize a metal compound sol, to suppress aggregation of the particulate condensate. The α-substituted β-diketone is preferably represented by the following general formula (b). In the formula (b), R₁, R₂, and R₃ each represent an alkyl group having 1 or more and 3 or less carbon atoms, and may be identical to or different from each other.

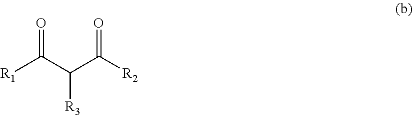

Examples of the α-substituted β-diketone include 3-methyl-2,4-pentanedione, 4-methyl-3,5-heptanedione, 3,5-dimethyl-2,4-hexanedione, and 3-ethyl-2,4-pentanedione. Of those, 3-methyl-2,4-pentanedione is particularly preferred. When the number of carbon atoms in each of R₁, R₂, and R₃ is smaller, remaining in the film after the film formation is avoided, and hence satisfactory film characteristics can be obtained. In addition, when the number of carbon atoms in R₃ is 0, a dispersion stabilization effect on the metal compound particles in the liquid becomes insufficient, and hence there is a risk in that the particle diameter of the particulate condensate may become large.

For maintaining the dispersed state, the content of the metal element of the metal alkoxide and the content of the α-substituted β-diketone preferably satisfy the following formula (4):

0.20≤a/d≤1.1 (4)

where: “a” represents the metal element content [mass %] of the metal alkoxide condensate with respect to the total amount of the sol liquid; and “d” represents the content [mass %] of the α-substituted β-diketone with respect to the total amount of the sol liquid.

a/d more preferably falls within 0.25≤a/d≤1.1.

When a/d is 0.20 or more, a coating film can be formed without causing the α-substituted β-diketone to remain in the film after the film formation, and an influence on the optical characteristics of the coating film by the α-substituted β-diketone can be avoided. In addition, when a/d is 1.1 or less, the ratio of the α-substituted β-diketone to the metal alkoxide is sufficiently large to suppress aggregation between the particulate condensates, and hence the dispersed state in the sol liquid can be kept.

[3] Water-Soluble Organic Solvent

The water-soluble organic solvent is preferably an organic solvent that is mixed without phase-separating when mixed with water. Even when the solubility in water is poor with a single organic solvent, two or more kinds of organic solvents may be used as long as sufficient water solubility is obtained. Examples of the water-soluble organic solvent include an alcohol-based solvent, a glycol-based solvent, a glycol ether-based solvent, an ether-based solvent, and a ketone-based solvent. The water-soluble organic solvent preferably contains at least one kind selected from the group consisting of: an alcohol-based solvent; a glycol-based solvent; a glycol ether-based solvent; an ether-based solvent; and a ketone-based solvent, and more preferably contains an alcohol-based solvent, a glycol-based solvent, or a glycol ether-based solvent. Preferred specific examples thereof include methanol, ethanol, 1-propanol, 2-propanol, 1-butanol, 2-butanol, tert-butanol, ethylene glycol, propylene glycol, diethylene glycol, dipropylene glycol, methyl cellosolve, ethyl cellosolve, butyl cellosolve, methyl carbitol, ethyl carbitol, butyl carbitol, propylene glycol monomethyl ether (1-methoxy-2-propanol), and propylene glycol monoethyl ether (1-ethoxy-2-propanol), and more preferred examples thereof include methanol, ethanol, 1-propanol, 2-propanol, tert-butanol, methyl cellosolve, ethyl cellosolve, butyl cellosolve, methyl carbitol, ethyl carbitol, propylene glycol monomethyl ether (1-methoxy-2-propanol), and propylene glycol monoethyl ether (1-ethoxy-2-propanol). Those organic solvents may be used alone or in combination thereof.

In addition, with regard to film formation of the coating film, an organic solvent having a boiling point at normal pressure of 130° C. or more is preferably incorporated at a ratio of 10 mass % or more, preferably 20 mass % or more, more preferably 30 mass % or more with respect to the total amount of the organic solvent. When the ratio of the solvent having a boiling point of 130° C. or more is 10 mass % or more, the ratio of the solvent having a fast volatilization rate becomes small, and hence a film defect hardly occurs when the film formation into a coating film is performed.

The content of the water-soluble organic solvent in the sol liquid is desirably 40 mass % or more, preferably 50 mass % or more, more preferably 60 mass % or more with respect to the total amount of the sol liquid. In the present invention, a solvent except the water-soluble organic solvent may also be used in combination, and also in that case, when the content of the water-soluble organic solvent falls within the above-mentioned ranges, a reduction in film uniformity when film formation is performed can be suppressed. When the content of the water-soluble organic solvent is 40 mass % or more, wettability to a base material can be more easily secured when coating is performed, and hence application unevenness hardly occurs.

[4] Inorganic Acid

Any inorganic acid may be used as long as the inorganic acid is an acid having a catalytic action of forming a condensate through hydrolysis of a metal alkoxide. Specifically, the inorganic acid preferably contains at least one or more kinds selected from the group consisting of: hydrochloric acid; sulfuric acid; nitric acid; and phosphoric acid, and more preferably contains hydrochloric acid.

The metal element content of the metal alkoxide condensate and the content of the inorganic acid preferably satisfy the relationship of the following formula (1):

4.0×10⁻⁵≤b/a≤3.5×10⁻⁴ (1)

where: “a” represents the metal element content [mass %] of the metal alkoxide condensate with respect to the total amount of the sol liquid; and “b” represents the content [mass %] of the inorganic acid with respect to the total amount of the sol liquid.

In order to moderately advance the hydrolysis and condensation reaction of the metal alkoxide, b/a more preferably falls within 4.6×10⁻⁵≤b/a≤3.2×10⁻⁴, and still more preferably falls within 7.0×10⁻⁵≤b/a≤2.0×10⁻⁴. In addition, the content “b” of the inorganic acid preferably falls within 9.10×10⁻⁵≤b≤7.40×10⁻⁴, more preferably falls within 9.10×10⁻⁵≤b≤6.00×10⁻⁴, and still more preferably falls within 1.00×10⁻⁴≤b≤4.00×10⁻⁴.

When b/a is 4.0×10⁻⁵ or more, the hydrolysis reaction and condensation reaction of the metal alkoxide are easily advanced, and uneven distribution or a crack hardly occurs when film formation is performed, and hence a uniform film can be easily obtained. In addition, when b/a is 3.5×10⁻⁴ or less, the particle distribution of the condensate hardly becomes wide. In addition, coarse particles hardly occur. Further, when water or an aqueous sol liquid is added, dispersion stability is hardly reduced.

[5] Organic Acid

The organic acid is not particularly limited, but is preferably an organic acid having one or more carboxyl groups and 6 or less carbon atoms. Specific examples thereof include acetic acid, formic acid, citric acid, malic acid, lactic acid, succinic acid, propionic acid, glycolic acid, malonic acid, glutaric acid, and tartaric acid. The organic acid preferably contains at least one kind selected from the group consisting of: acetic acid; formic acid; citric acid; malic acid; lactic acid; succinic acid; propionic acid; glycolic acid; malonic acid; glutaric acid; and tartaric acid, more preferably contains at least one or more kinds selected from the group consisting of: acetic acid; formic acid; citric acid; malic acid; lactic acid; and succinic acid, and still more preferably contains acetic acid or formic acid.

The organic acid is added for the purpose of improving the dispersion stability of the metal alkoxide condensate. The inventors of the present invention have made extensive investigations on a compound that can keep the dispersibility of the condensate by stably coordinating to the condensate in both of hydrophobic and hydrophilic solvents in order to cope with the problem that the dispersion stability is largely reduced when the sol liquid containing the metal alkoxide condensate is mixed with the solvent having high hydrophilicity such as water. As a result, the inventors have found that the problem can be solved by adding an organic acid, preferably an organic acid having a low acid dissociation constant to an inorganic acid.

As described above, the inorganic acid is used for the purpose of hydrolyzing the metal alkoxide to produce a condensate. The inorganic acid is incorporated in the sol liquid as it is, and when water is added, an acid dissociation degree is liable to become higher than that before the addition of water. Accordingly, further hydrolysis of the metal alkoxide that remains in the condensate particles is liable to be promoted, and hence aggregation between the condensate particles occurs, and coarse particles and cloudiness are liable to occur.

In contrast, when an organic acid is added, the organic acid, particularly the organic acid having a small acid dissociation constant, can be present in the sol liquid in a condition of having high affinity to the condensate particles. In addition, also when the sol liquid is mixed with water, in general, acid dissociation more hardly advances in the organic acid than in the inorganic acid, and hence the organic stably coordinates in the vicinity of the condensate particles. Further, the organic acid can be present in the vicinity of the condensate particles, and hence further hydrolysis of the alkoxide that remains in the condensate particles can also be suppressed.

In addition, in the present invention, the α-substituted β-diketone is used as a dispersion stabilizer of the condensate particles, and hence the organic acid has affinity to a hydrophobic moiety of the α-substituted β-diketone coordinating to the condensate particles. Accordingly, even when a medium of the sol liquid is changed from highly hydrophobic to hydrophilic by mixing of water, in general, a higher priority is placed on the acid dissociation of the inorganic acid than that of the organic acid, and hence it is conceived that the dissociation of the organic acid moderately advances in accordance with an increase in hydrophilicity of the medium. As a result, it is conceived that the coordination between the condensate particles and the α-substituted β-diketone can be stably kept. When the organic acid is not used, even though the α-substituted β-diketone can stably coordinate to the condensate in the hydrophobic medium, coordination of the α-substituted β-diketone becomes unstable in a medium increased in hydrophilicity by, for example, mixing with water, with the result that aggregation between the condensate particles is liable to occur.

The metal element content of the metal alkoxide condensate and the content of the organic acid preferably satisfy the relationships of the following formula (2) and the following formula (3):

0.020≤c≤20 (2)

0.025≤c/a≤3.3 (3)

where: “a” represents the metal element content [mass %] of the metal alkoxide condensate with respect to the total amount of the sol liquid; and “c” represents the content [mass %] of the organic acid with respect to the total amount of the sol liquid.

The content “c” of the organic acid more preferably falls within 0.020≤c≤15, and most preferably falls within 0.10≤c≤10. In addition, c/a more preferably falls within 0.030≤c/a≤3.3, and most preferably falls within 0.050≤c/a≤2.5. These ranges are desired because the dispersion stability is further improved when water is added.

When the content “c” of the organic acid falls within the ranges of the formula (2) and the formula (3), a condition having an affinity of the organic acid to the condensate particles becomes stable, and hence when the sol liquid is mixed with, for example, water, the particle distribution of the condensate particles hardly becomes wide. Accordingly, coarse particles hardly occur.

The content of the α-substituted β-diketone and the content of the organic acid preferably satisfy the relationship of the following formula (5):

3.0×10⁻³≤c/d≤5.0 (5)

where: “c” represents the content [mass %] of the organic acid with respect to the total amount of the sol liquid; and “d” represents the content [mass %] of the α-substituted β-diketone with respect to the total amount of the sol liquid.

c/d more preferably falls within 0.030≤c/d≤5.0, and most preferably falls within 0.050≤c/d≤4.0. These ranges are desired because the dispersion stability at the time of addition of water is further improved.

When c/d falls within the range of the formula (5), a condition of having an affinity of the α-substituted β-diketone to the organic acid becomes stable, and hence when the sol liquid is mixed with, for example, water, the particle distribution of the condensate particles hardly becomes wide. Accordingly, coarse particles hardly occur.

<Mixed Liquid>

The mixed liquid of the present invention contains the sol liquid of the present invention and water. The water in the mixed liquid may be water to be incorporated in the aqueous sol liquid. The mixed liquid has a pH of preferably 2.00 or more and 7.00 or less, more preferably 2.50 or more and 7.00 or less, still more preferably 3.00 or more and 6.50 or less. When the pH is 2.00 or more, deterioration such as erosion of a base material surface at the time of film formation hardly occurs, and when the pH is 7.00 or less, a reduction in dispersion stability hardly occurs when water or an aqueous sol liquid is added.

The mixed liquid allows the dispersion stability of the condensate particles in the sol liquid of the present invention to become good, and workability in a coating step becomes good, and hence a coating film having good characteristics can be obtained. As a method of preparing the mixed liquid, a known method may be adopted, and hence the mixed liquid may be produced by mixing water or an aqueous sol liquid, or any of various solvents to the sol liquid of the present invention.

<Coating Film and Method of Producing Coating Film>

The coating film of the present invention is formed by heating the sol liquid or the mixed liquid of the present invention. In addition, a method of producing the coating film of the present invention includes in the following order: an application step of applying, onto a base material, the sol liquid or the mixed liquid of the present invention; and a heating step of heating the base material at a temperature equal to or less than the glass transition temperature of the base material.

[1] Application Step

The base material only needs to be a base material that can endure the heating step. As the base material, for example, hard glass, soft glass, plastic, a semiconductor substrate such as silicon, or a metal plate may be used. In addition, those base materials may each have an inorganic film on its surface. For example, an inorganic film or the like formed on the semiconductor substrate may be adopted as the base material, and the coating film may be formed on its surface.

As an application method, there are given, for example, wet processes, such as a dipping method, a spin coating method, a spray method, a printing method, and a flow coating method. The application method is not limited to those methods.

[2] Heating Step

In the heating step, the condensation reaction of the condensate in the sol liquid or the mixed liquid is advanced by heating the base material applied in the application step, to thereby form a metal oxide, and a film can be formed by drying a coating film.

<Method of Producing Sol Liquid>

A method of producing a sol liquid of the present invention includes: a condensation step of subjecting a metal alkoxide to condensation by adding an inorganic acid to a reaction liquid obtained by mixing the metal alkoxide and an α-substituted β-diketone with a water-soluble organic solvent; and an organic acid addition step of adding an organic acid to the reaction liquid after the condensation step. The addition amount of each component is preferably set to an addition amount that enables the content of the component in the sol liquid to fall within the range described in the section “Sol Liquid”.

The production method of the present invention may include a step of appropriately adding various additives, such as a pH adjuster and a viscosity modifier, in addition to the above-mentioned steps. When the additive is added, the addition is preferably performed after the organic acid addition step because the dispersion stability of the condensate particles can be easily kept.

[1] Condensation Step

As a method of mixing the metal alkoxide and the α-substituted β-diketone with the water-soluble organic solvent, a known method can be used, and an example thereof is a method of sequentially adding the metal alkoxide and the α-substituted β-diketone to a water-soluble organic solvent, followed by stirring and mixing. Subsequently, an inorganic acid is added to a reaction liquid. In a method of adding the inorganic acid, only the inorganic acid may be added, but the method is preferably a method of gradually adding the inorganic acid as a solution obtained by adding the inorganic acid to the water-soluble organic solvent and stirring the mixture. The above-mentioned method is desired because heat generation is suppressed when the inorganic acid is added and because the hydrolysis reaction can be uniformly advanced. After that, the hydrolysis reaction and condensation reaction of the metal alkoxide are performed to form a particulate condensate. In this case, the reactions are preferably performed under heating. A reaction temperature is preferably 50° C. or more and 120° C. or less. The reaction may also be performed at a reaction temperature equal to or higher than the boiling point of the water-soluble organic solvent using a closed container.

[2] Organic Acid Addition Step

As a method of adding an organic acid to the reaction liquid having formed therein the particulate condensate in the condensation step, a known method may be adopted, and it is preferable to add the reaction liquid while stirring. In addition, when the organic acid is added, the addition is desirably performed under a condition which the reaction liquid is cooled to room temperature. Subsequently, heat treatment of the reaction liquid is desirably performed because a condition of the affinity of the organic acid to the particulate condensate becomes good. The heat treatment is performed at preferably 20° C. or more and 100° C. or less, more preferably 30° C. or more and 60° C. or less. A time period of the heat treatment is preferably 5 minutes or more and 1 hour or less. In the organic acid addition step, the α-substituted β-diketone may be added as a stabilizer in addition to the organic acid.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass, unless otherwise stated.

In Tables 1 to 3, the up arrow means that the content is the same as that in the column immediately above. In addition, in Tables 1 to 3, a content of a component except a metal of a metal alkoxide condensate, an inorganic acid, an organic acid, an α-substituted β-diketone, and a water-soluble organic solvent such as a content of a moiety except a metal of the metal alkoxide condensate may be determined by subtracting “a+b+c+d+content of water-soluble organic solvent” from 100.

### Example 1

<Condensation Step>

As shown in Table 1, 10.0 parts of a solution of tetra-n-butoxyzirconium in butanol (concentration of tetra-n-butoxyzirconium: 85 wt %, the metal alkoxide), 19.1 parts of 2-propanol (the water-soluble organic solvent), and 1.9 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 44.7 parts of 2-propanol (the water-soluble organic solvent), and 28.1 parts of 1-ethoxy-2-propanol (the water-soluble organic solvent) was added dropwise under stirring over 30 minutes, and then the mixture was subjected to a reaction for 2 hours while the temperature was kept at 70° C. in an oil bath.

<Organic Acid Addition Step>

As shown in Table 1, acetic acid (the organic acid) was added dropwise to the reaction liquid after the condensation step so that the concentration became 0.1% while the reaction liquid was stirred at 130 rpm. Heat treatment was performed for 30 minutes while the stirring is continued and the temperature is kept at 30° C. in an oil bath. Thus, a sol liquid containing a particulate incomplete condensate of a zirconium alkoxide was obtained. The content of each substance in the column “Organic acid addition step” of Table 1 relates to the sol liquid.

Analysis results of an X-ray diffraction (XRD) of zirconium oxide powder obtained by sintering the sol liquid in an electric furnace at 300° C. for 2 hours are shown in FIGURE.

<Production of Coating Film>

A substrate (slide glass with ground edges (mizufuchimigaki), material: soda glass, rectangular shape, 3t×40×40 mm) was subjected to ultrasonic cleaning with 2-propanol for 30 minutes, followed by drying. The resultant was subjected to ozone cleaning for 10 minutes, and dust was removed with a spray for cleaning a substrate. Thus, a glass substrate for coating was obtained. 0.3 ml of the sol liquid was applied onto the glass substrate for coating by spin coating at a rotation number of 2,685 rpm for 60 seconds using a spin coating apparatus (product name: “1H-D7”, manufactured by Mikasa Co., Ltd.), and the resultant was baked in an electric furnace at 300° C. for 2 hours. Thus, a coating film formed of the sol liquid was produced.

Further, a coating film formed of the mixed liquid was produced in the same manner as described above using 0.3 ml of a mixed liquid obtained by mixing 1 part of an aqueous silica sol (product name: “ST-OXS”, manufactured by Nissan Chemical Industries, Ltd.) into 1 part of the sol liquid.

<Evaluations>

The sol liquid and the coating film were evaluated as described below. The results are shown in Table 4.

(Evaluation 1: Median Diameter of Particulate Condensate)

A median diameter of the particulate condensate in the sol liquid was measured with a nanoparticle diameter measurement apparatus (product name: “NANOTRAC FLEX”, manufactured by MicrotracBEL Corp., volume distribution method). Known values for a metal oxide and a main solvent were used as numerical values of a particle refractive index and a solvent refractive index, respectively.

(Evaluation 2: pH after Addition of Water)

Water in each amount shown in Table 4 was added to 1 part of the sol liquid, and then a pH was measured using a portable pH meter D-54 (manufactured by Horiba, Ltd.).

(Evaluation 3: Dispersibility after Addition of Water)

Ion-exchanged water in each amount shown in Table 4 was added to 1 part of the sol liquid. The resultant was then stored in a refrigerator (5° C.) and visually observed. For a time period for which no precipitation or gelation occurs, dispersibility was evaluated in accordance with the following evaluation criteria.
A: 1 month or more
B: 1 week or more and less than 1 month
C: 1 day or more and less than 1 week
D: less than 1 day

(Evaluation 4: Film-Forming Property of Coating Film)

A film thickness of the coating film was measured with a reflection spectroscopic film thickness meter FE-3000 (manufactured by Otsuka Electronics Co., Ltd.), and an appearance of the coating film was visually observed. Reflection spectra were measured at 5 points (center and 4 points in the vicinity of corners), and fitting was performed by the least square method. Thus, the film thickness was determined. A value of (maximum value−minimum value)/(average value)×100 was adopted as a variation in film thickness [%], and a film-forming property was evaluated in accordance with the following evaluation criteria.
A: The film can be uniformly formed (the variation in film thickness is less than 30%).
B: A difference in film thickness is partially present (the variation in film thickness is 30% or more and less than 100%).
C: An uncoated part is present (the part can be visually observed or the variation in film thickness is 100% or more).

### Example 2

A sol liquid containing a particulate incomplete condensate of a zirconium alkoxide was obtained in the same manner as in Example 1 except that, as shown in Table 1, in the organic acid addition step, the period of time of the heat treatment was changed to 5 minutes. Further, a coating film was produced in the same manner as in Example 1. Then, evaluations were performed. The results are shown in Table 4.

### Example 3

A sol liquid containing a particulate incomplete condensate of a zirconium alkoxide was obtained in the same manner as in Example 1 except that, as shown in Table 1, in the organic acid addition step, the period of time of the heat treatment was changed to 60 minutes. Further, a coating film was produced in the same manner as in Example 1. Then, evaluations were performed. The results are shown in Table 4.

### Example 4

A sol liquid containing a particulate incomplete condensate of a zirconium alkoxide was obtained in the same manner as in Example 1 except that, as shown in Table 1, in the organic acid addition step, the temperature of the heat treatment was changed to 20° C. Further, a coating film was produced in the same manner as in Example 1. Then, evaluations were performed. The results are shown in Table 4.

### Example 5

A sol liquid containing a particulate incomplete condensate of a zirconium alkoxide was obtained in the same manner as in Example 1 except that, as shown in Table 1, in the organic acid addition step, the temperature of the heat treatment was changed to 70° C. Further, a coating film was produced in the same manner as in Example 1. Then, evaluations were performed. The results are shown in Table 4.

### Example 6

As shown in Table 1, a sol liquid containing a particulate incomplete condensate of a zirconium alkoxide was obtained in the same manner as in Example 1. A coating film was produced in the same manner as in Example 1 except that a mixed liquid was used in which the mixing amount of the aqueous silica sol was changed to 1 part with respect to 9 parts of the sol liquid. Then, evaluations were performed. The results are shown in Table 4.

### Example 7

A sol liquid containing a particulate incomplete condensate of a zirconium alkoxide was obtained in the same manner as in Example 1 except that, as shown in Table 1, in the organic acid addition step, acetic acid was added dropwise so that the concentration became 0.7%. A coating film was produced in the same manner as in Example 1 except that a mixed liquid was used, in which the mixing amount of the aqueous silica sol was changed to 9 parts with respect to 1 part of the sol liquid. Then, evaluations were performed. The results are shown in Table 4.

### Example 8

A sol liquid containing a particulate incomplete condensate of a zirconium alkoxide was obtained in the same manner as in Example 1 except that, as shown in Table step, acetic acid was added dropwise so that the concentration became 0.02%. Further, a coating film was produced in the same manner as in Example 1. Then, evaluations were performed. The results are shown in Table 4.

<Condensation Step>

4.0 Parts of a solution of tetra-n-butoxyzirconium in butanol (concentration of tetra-n-butoxyzirconium: 85 wt %, the metal alkoxide), 20.8 parts of 2-propanol (the water-soluble organic solvent), and 0.8 part of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.3 part of 0.01 N hydrochloric acid (the inorganic acid), 48.6 parts of 2-propanol (the water-soluble organic solvent), and 30.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 9

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 20%. Further, a coating film was produced in the same manner as in Example 1. Then, evaluations were performed. The results are shown in Table 4.

<Condensation Step>

40.0 Parts of a solution of tetra-n-butoxyzirconium in butanol (concentration of tetra-n-butoxyzirconium: 85 wt %, the metal alkoxide), 10.8 parts of 2-propanol (the water-soluble organic solvent), and 7.8 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 2.6 parts of 0.01 N hydrochloric acid (the inorganic acid), 25.2 parts of 2-propanol (the water-soluble organic solvent), and 18.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 10

A sol liquid containing a particulate incomplete condensate of a zirconium alkoxide was obtained in the same manner as in Example 1 except that, as shown in Table 1, the condensation step was changed as described below, and that in the organic acid addition step, acetic acid was added dropwise so that the concentration became 0.02%. Further, a coating film was produced in the same manner as in Example 1. Then, evaluations were performed. The results are shown in Table 4.

<Condensation Step>

4.0 Parts of a solution of tetra-n-butoxyzirconium in butanol (concentration of tetra-n-butoxyzirconium: 85 wt %, the metal alkoxide), 20.7 parts of 2-propanol (the water-soluble organic solvent), and 0.8 part of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 48.4 parts of 2-propanol (the water-soluble organic solvent), and 29.9 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 11

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 20%. Further, a coating film was produced in the same manner as in Example 1. Then, evaluations were performed. The results are shown in Table 4.

<Condensation Step>

40.0 Parts of a solution of tetra-n-butoxyzirconium in butanol (concentration of tetra-n-butoxyzirconium: 85 wt %, the metal alkoxide), 11.1 parts of 2-propanol (the water-soluble organic solvent), and 7.8 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 1.0 part of 0.01 N hydrochloric acid (the inorganic acid), 26.0 parts of 2-propanol (the water-soluble organic solvent), and 18.5 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 12

A sol liquid containing a particulate incomplete condensate of a zirconium alkoxide was obtained in the same manner as in Example 1 except that, as shown in Table 1, in the organic acid addition step, the temperature of the heat treatment was changed to 10° C. Further, a coating film was produced in the same manner as in Example 1. Then, evaluations were performed. The results are shown in Table 4.

### Example 13

A sol liquid containing a particulate incomplete condensate of a zirconium alkoxide was obtained in the same manner as in Example 1 except that, as shown in Table 1, in the organic acid addition step, the period of time of the heat treatment was changed to 3 minutes. Further, a coating film was produced in the same manner as in Example 1. Then, evaluations were performed. The results are shown in Table 4.

### Example 14

A sol liquid containing a particulate incomplete condensate of a zirconium alkoxide was obtained in the same manner as in Example 1 except that, as shown in Table 1, in the organic acid addition step, the period of time of the heat treatment was changed to 90 minutes. Further, a coating film was produced in the same manner as in Example 1. Then, evaluations were performed. The results are shown in Table 4.

### Example 15

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 0.02%. Further, a coating film was produced in the same manner as in Example 1. Then, evaluations were performed. The results are shown in Table 4.

<Condensation Step>

3.0 Parts of a solution of tetra-n-butoxyzirconium in butanol (concentration of tetra-n-butoxyzirconium: 85 wt %, the metal alkoxide), 21.1 parts of 2-propanol (the water-soluble organic solvent), and 0.6 part of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.2 part of 0.01 N hydrochloric acid (the inorganic acid), 49.2 parts of 2-propanol (the water-soluble organic solvent), and 30.4 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 16

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 20%. Further, a coating film was produced in the same manner as in Example 1. Then, evaluations were performed. The results are shown in Table 4.

<Condensation Step>

50.0 Parts of a solution of tetra-n-butoxyzirconium in butanol (concentration of tetra-n-butoxyzirconium: 85 wt %, the metal alkoxide), 8.0 parts of 2-propanol (the water-soluble organic solvent), and 9.7 parts of 3-methyl-2,4-pentanedione (the α-substituted (3-diketone) were loaded into a reaction vessel equipped with a temperature gauge, a dropping funnel, and a stirring device, and the contents were stirred at 130 rpm.

Subsequently, a solution obtained by mixing 3.3 parts of 0.01 N hydrochloric acid (the inorganic acid), 18.7 parts of 2-propanol (the water-soluble organic solvent), and 14.7 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 17

A sol liquid containing a particulate incomplete condensate of a zirconium alkoxide was obtained in the same manner as in Example 15 except that, as shown in Table 1, in the organic acid addition step, acetic acid was added dropwise so that the concentration became 0.002%. Further, a coating film was produced in the same manner as in Example 1. Then, evaluations were performed. The results are shown in Table 4.

### Example 18

A sol liquid containing a particulate incomplete condensate of a zirconium alkoxide was obtained in the same manner as in Example 16 except that, as shown in Table 1, in the organic acid addition step, acetic acid was added dropwise so that the concentration became 30%. Further, a coating film was produced in the same manner as in Example 1. Then, evaluations were performed. The results are shown in Table 4.

### Example 19

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 0.002%. Further, a coating film was produced in the same manner as in Example 1. Then, evaluations were performed. The results are shown in Table 4.

<Condensation Step>

3.0 Parts of a solution of tetra-n-butoxyzirconium in butanol (concentration of tetra-n-butoxyzirconium: 85 wt %, the metal alkoxide), 21.0 parts of 2-propanol (the water-soluble organic solvent), and 0.6 part of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.8 part of 0.01 N hydrochloric acid (the inorganic acid), 48.9 parts of 2-propanol (the water-soluble organic solvent), and 30.2 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 20

A sol liquid containing a particulate incomplete condensate of a zirconium alkoxide was obtained in the same manner as in Example 1 except that, as shown in Table 1, the condensation step was changed as described below, and, in the organic acid addition step, acetic acid was added dropwise so that the concentration became 30%. Further, a coating film was produced in the same manner as in Example 1. Then, evaluations were performed. The results are shown in Table 4.

<Condensation Step>

50.0 Parts of a solution of tetra-n-butoxyzirconium in butanol (concentration of tetra-n-butoxyzirconium: 85 wt %, the metal alkoxide), 8.5 parts of 2-propanol (the water-soluble organic solvent), and 9.7 parts of 3-methyl-2,4-pentanedione (the α-substituted (3-diketone) were loaded into a reaction vessel equipped with a temperature gauge, a dropping funnel, and a stirring device, and the contents were stirred at 130 rpm.

Subsequently, a solution obtained by mixing 0.8 part of 0.01 N hydrochloric acid (the inorganic acid), 19.9 parts of 2-propanol (the water-soluble organic solvent), and 15.4 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 21

A sol liquid containing a particulate incomplete condensate of a zirconium alkoxide was obtained in the same manner as in Example 1 except that, as shown in Table 1, in the organic acid addition step, the organic acid was changed to formic acid. Further, a coating film was produced in the same manner as in Example 1. Then, evaluations were performed. The results are shown in Table 4.

### Example 22

A sol liquid containing a particulate incomplete condensate of a zirconium alkoxide was obtained in the same manner as in Example 1 except that, as shown in Table 1, in the organic acid addition step, the organic acid was changed to lactic acid. Further, a coating film was produced in the same manner as in Example 1. Then, evaluations were performed. The results are shown in Table 4.

### Example 23

A sol liquid containing a particulate incomplete condensate of a zirconium alkoxide was obtained in the same manner as in Example 1 except that, as shown in Table 1, in the organic acid addition step, the organic acid was changed to citric acid. Further, a coating film was produced in the same manner as in Example 1. Then, evaluations were performed. The results are shown in Table 4.

### Example 24

A sol liquid containing a particulate incomplete condensate of a zirconium alkoxide was obtained in the same manner as in Example 1 except that, as shown in Table 1, in the organic acid addition step, the organic acid was changed to malic acid. Further, a coating film was produced in the same manner as in Example 1. Then, evaluations were performed. The results are shown in Table 4.

### Example 25

A sol liquid containing a particulate incomplete condensate of a zirconium alkoxide was obtained in the same manner as in Example 1 except that, as shown in Table 1, in the organic acid addition step, the organic acid was changed to succinic acid. Further, a coating film was produced in the same manner as in Example 1. Then, evaluations were performed. The results are shown in Table 4.

### Example 26

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tetramethoxyzirconium (the metal alkoxide), 21.0 parts of 2-propanol (the water-soluble organic solvent), and 3.3 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 1.1 parts of 0.01 N hydrochloric acid (the inorganic acid), 49.1 parts of 2-propanol (the water-soluble organic solvent), and 30.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 27

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tetraethoxyzirconium (the metal alkoxide), 19.8 parts of 2-propanol (the water-soluble organic solvent), and 2.6 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.9 part of 0.01 N hydrochloric acid (the inorganic acid), 46.2 parts of 2-propanol (the water-soluble organic solvent), and 28.4 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 28

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tetra-n-propoxyzirconium (the metal alkoxide), 19.0 parts of 2-propanol (the water-soluble organic solvent), and 2.1 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 44.4 parts of 2-propanol (the water-soluble organic solvent), and 27.2 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 29

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tetra-i-propoxyzirconium (the metal alkoxide), 19.0 parts of 2-propanol (the water-soluble organic solvent), and 2.2 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 44.4 parts of 2-propanol (the water-soluble organic solvent), and 27.2 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 30

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tetra-i-butoxyzirconium (the metal alkoxide), 18.4 parts of 2-propanol (the water-soluble organic solvent), and 1.8 parts of 3-methyl-2,4-pentanedione (the α-substituted β-diketone) were loaded into a reaction vessel including a temperature gauge, a dropping funnel, and a stirring device, and the contents were stirred at 130 rpm.

Subsequently, a solution obtained by mixing 0.6 part of 0.01 N hydrochloric acid (the inorganic acid), 43.0 parts of 2-propanol (the water-soluble organic solvent), and 26.4 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 31

A sol liquid containing a particulate incomplete condensate of an aluminum alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of tri-sec-butoxyaluminum (the metal alkoxide), 20.3 parts of 2-propanol (the water-soluble organic solvent), and 2.9 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 47.5 parts of 2-propanol (the water-soluble organic solvent), and 29.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 32

A sol liquid containing a particulate incomplete condensate of a niobium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

8.0 Parts of penta-n-butoxyniobium (the metal alkoxide), 17.9 parts of 2-propanol (the water-soluble organic solvent), and 1.5 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.5 part of 0.01 N hydrochloric acid (the inorganic acid), 41.8 parts of 2-propanol (the water-soluble organic solvent), and 25.6 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 33

A sol liquid containing a particulate incomplete condensate of a tungsten alkoxide was obtained in the same manner as in Example 1 except that, as shown in Table 2, the condensation step and the organic acid addition step were each changed as described below. Further, a coating film was produced in the same manner as in Example 1. Then, evaluations were performed. The results are shown in Table 5.

<Condensation Step>

8.0 Parts of tungsten(V) ethoxide (the metal alkoxide), 18.2 parts of 2-propanol (the water-soluble organic solvent), and 1.7 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.6 part of 0.01 N hydrochloric acid (the inorganic acid), 42.5 parts of 2-propanol (the water-soluble organic solvent), and 26.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

<Organic Acid Addition Step>

While the reaction liquid after the condensation step was stirred at 130 rpm, 12.2 parts of 3-methyl-2,4-pentanedione (the α-substituted β-diketone) was added, and then acetic acid (the organic acid) was added dropwise so that the concentration became 5%. Under a condition in which the stirring was continued, heat treatment was performed for 30 minutes while the temperature was kept at 30° C. in an oil bath. Thus, a sol liquid containing a particulate incomplete condensate of a tungsten alkoxide was obtained.

### Example 34

A sol liquid containing a particulate incomplete condensate of a tantalum alkoxide was obtained in the same manner as in Example 1 except that, as shown in Table 2, the condensation step and the organic acid addition step were each changed as described below. Further, a coating film was produced in the same manner as in Example 1. Then, evaluations were performed. The results are shown in Table 5.

<Condensation Step>

8.0 Parts of pentaethoxytantalum (the metal alkoxide), 18.3 parts of 2-propanol (the water-soluble organic solvent), and 1.7 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.6 part of 0.01 N hydrochloric acid (the inorganic acid), 42.6 parts of 2-propanol (the water-soluble organic solvent), and 26.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

<Organic Acid Addition Step>

While the reaction liquid after the condensation step was stirred at 130 rpm, 12.2 parts of 3-methyl-2,4-pentanedione (the α-substituted β-diketone) was added, and then acetic acid (the organic acid) was added dropwise so that the concentration became 5%. Under a condition in which the stirring was continued, heat treatment was performed for 30 minutes while the temperature was kept at 30° C. in an oil bath. Thus, a sol liquid containing a particulate incomplete condensate of a tantalum alkoxide was obtained.

### Example 35

A sol liquid containing a particulate incomplete condensate of a tantalum alkoxide was obtained in the same manner as in Example 1 except that, as shown in Table 2, the condensation step was changed as described below, and, in the organic acid addition step, acetic acid was added dropwise so that the concentration became 5%. Further, a coating film was produced in the same manner as in Example 1. Then, evaluations were performed. The results are shown in Table 5.

<Condensation Step>

8.0 Parts of pentaethoxytantalum (the metal alkoxide), 18.3 parts of 2-propanol (the water-soluble organic solvent), and 13.9 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.6 part of 0.01 N hydrochloric acid (the inorganic acid), 42.6 parts of 2-propanol (the water-soluble organic solvent), and 26.1 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 36

A sol liquid containing a particulate incomplete condensate of a zirconium alkoxide was obtained in the same manner as in Example 1 except that, as shown in Table 2, the condensation step was changed as described below. Further, a coating film was produced in the same manner as in Example 1. Then, evaluations were performed. The results are shown in Table 5.

<Condensation Step>

10.0 Parts of a solution of tetra-n-butoxyzirconium in butanol (concentration of tetra-n-butoxyzirconium: 85 wt %, the metal alkoxide), 20.0 parts of 2-propanol (the water-soluble organic solvent), and 2.4 parts of 3,5-dimethyl-2,4-hexanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 46.8 parts of 2-propanol (the water-soluble organic solvent), and 29.4 parts of 1-ethoxy-2-propanol (the water-soluble organic solvent) was added dropwise under stirring over 30 minutes, and then the mixture was subjected to a reaction for 2 hours while the temperature is kept at 70° C. in an oil bath.

### Example 37

A sol liquid containing a particulate incomplete condensate of a zirconium alkoxide was obtained in the same manner as in Example 1 except that, as shown in Table 3, in the condensation step, the inorganic acid was changed to sulfuric acid. Further, a coating film was produced in the same manner as in Example 1. Then, evaluations were performed. The results are shown in Table 5.

### Example 38

A sol liquid containing a particulate incomplete condensate of a zirconium alkoxide was obtained in the same manner as in Example 1 except that, as shown in Table 3, in the condensation step, the inorganic acid was changed to nitric acid. Further, a coating film was produced in the same manner as in Example 1. Then, evaluations were performed. The results are shown in Table 5.

### Example 39

A sol liquid containing a particulate incomplete condensate of a zirconium alkoxide was obtained in the same manner as in Example 1 except that, as shown in Table 3, in the condensation step, the inorganic acid was changed to phosphoric acid. Further, a coating film was produced in the same manner as in Example 1. Then, evaluations were performed. The results are shown in Table 5.

### Example 40

A sol liquid containing a particulate incomplete condensate of a zirconium alkoxide was obtained in the same manner as in Example 1 except that, as shown in Table 3, in the condensation step, 2-propanol was changed to methanol, and the reaction was performed while the temperature was kept at 60° C. in an oil bath. Further, a coating film was produced in the same manner as in Example 1. Then, evaluations were performed. The results are shown in Table 5.

### Example 41

A sol liquid containing a particulate incomplete condensate of a zirconium alkoxide was obtained in the same manner as in Example 1 except that, as shown in Table 3, in the condensation step, 2-propanol was changed to ethanol. Further, a coating film was produced in the same manner as in Example 1. Then, evaluations were performed. The results are shown in Table 5.

### Example 42

A sol liquid containing a particulate incomplete condensate of a zirconium alkoxide was obtained in the same manner as in Example 1 except that, as shown in Table 3, in the condensation step, 2-propanol was changed to 1-propanol. Further, a coating film was produced in the same manner as in Example 1. Then, evaluations were performed. The results are shown in Table 5.

### Example 43

As shown in Table 3, in the condensation step, 2-propanol was changed to ethyl cellosolve, and the reaction was performed while the temperature was kept at 105° C. in an oil bath, and, in the organic acid addition step, the temperature of the heat treatment was changed to 100° C. A sol liquid containing a particulate incomplete condensate of a zirconium alkoxide was obtained in the same manner as in Example 1 except for the foregoing. Further, a coating film was produced in the same manner as in Example 1. Then, evaluations were performed. The results are shown in Table 5.

### Example 44

As shown in Table 3, in the condensation step, 2-propanol was changed to butyl carbitol, and the reaction was performed while the temperature was kept at 105° C. in an oil bath, and, in the organic acid addition step, the temperature of the heat treatment was changed to 120° C. A sol liquid containing a particulate incomplete condensate of a zirconium alkoxide was obtained in the same manner as in Example 1 except for the foregoing. Further, a coating film was produced in the same manner as in Example 1. Then, evaluations were performed. The results are shown in Table 5.

### Comparative Example 1

As shown in Table 3, the condensation step was changed as described below. Further, a coating film was produced in the same manner as in Example 1. Then, evaluations were performed. The results are shown in Table 5. In the column “Organic acid addition step” of Table 3, composition when the condensation step was discontinued is shown.

<Condensation Step>

10.0 Parts of a solution of tetra-n-butoxyzirconium in butanol (concentration of tetra-n-butoxyzirconium: 85 wt %, the metal alkoxide) and 19.1 parts of 2-propanol (the water-soluble organic solvent) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid), 44.7 parts of 2-propanol (the water-soluble organic solvent), and 28.1 parts of 1-ethoxy-2-propanol (the water-soluble organic solvent) was added dropwise under stirring over 30 minutes, and then the reaction was performed while the temperature was kept at 70° C. in an oil bath. However, precipitation occurred in the middle of the reaction, and hence the reaction was discontinued.

### Comparative Example 2

A sol liquid containing a particulate incomplete condensate of a zirconium alkoxide was obtained in the same manner as in Example 1 except that, as shown in Table 3, the condensation step was changed as described below. Further, a coating film was produced in the same manner as in Example 1. Then, evaluations were performed. The results are shown in Table 5.

<Condensation Step>

10.0 Parts of a solution of tetra-n-butoxyzirconium in butanol (concentration of tetra-n-butoxyzirconium: 85 wt %, the metal alkoxide), 19.1 parts of 2-ethyl-1-butanol (a water-insoluble organic solvent), and 1.9 parts of 3-methyl-2,4-pentanedione (the α-substituted β-diketone) were loaded into a reaction vessel equipped with a temperature gauge, a dropping funnel, and a stirring device, and the contents were stirred at 130 rpm.

Subsequently, a solution obtained by mixing 0.7 part of 0.01 N hydrochloric acid (the inorganic acid) and 72.7 parts of 2-ethyl-1-butanol (the water-insoluble organic solvent) was added dropwise under stirring over 30 minutes, and then the mixture was subjected to a reaction for 2 hours while the temperature is kept at 105° C. in an oil bath.

### Comparative Example 3

A sol liquid containing a particulate incomplete condensate of a zirconium alkoxide was obtained in the same manner as in Example 1 except that, as shown in Table 3, the organic acid addition step was not performed. Further, a coating film was produced in the same manner as in Example 1. Then, evaluations were performed. The results are shown in Table 5. In the column “organic acid addition step” of Table 3, composition when the condensation step was completed is shown.

### Comparative Example 4

A sol liquid containing a particulate incomplete condensate of a zirconium alkoxide was obtained in the same manner as in Example 1 except that, as shown in Table 3, in the organic acid addition step, sulfuric acid was added in place of the organic acid. Further, a coating film was produced in the same manner as in Example 1. Then, evaluations were performed. The results are shown in Table 5. A description with regard to sulfuric acid is shown in a column with regard to the organic acid of Table 3.

TABLE 1

| | | | | | | Organic acid addition step | | | | | | | |
|---|---|---|---|---|---|---|---|---|---|---|---|---|---|
| | | | | | | | | | | | Content | | |
| | | | | | | | | | | | [%] of | | |
| | Condensation step | | | | | | | | | | water- | Heat treatment | |
| | | α-Substi- | Inor- | | | | | | | | soluble | | Time |
| | Metal | tuted | ganic | Solvent | Solvent | Organic | | | | | organic | Tempera- | period |
| | alkoxide | β-diketone | acid | 1 | 2 | acid | b/a | c/a | a/d | c/d | solvent | ture [° C.] | [min] |
| Exam- | Tetra-n- | 3-Methyl- | Hydro- | 2- | 1- | Acetic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 1 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 30 | 5 |
| ple | butoxy- | 2,4- | chloric | Propanol | Ethoxy- | acid | 10⁻⁴ | | | | | | |
| 2 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 30 | 60 |
| ple | butoxy- | 2,4- | chloric | Propanol | Ethoxy- | acid | 10⁻⁴ | | | | | | |
| 3 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 20 | 30 |
| ple | butoxy- | 2,4- | chloric | Propanol | Ethoxy- | acid | 10⁻⁴ | | | | | | |
| 4 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 70 | 30 |
| ple | butoxy- | 2,4- | chloric | Propanol | Ethoxy- | acid | 10⁻⁴ | | | | | | |
| 5 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 6 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.36 | 1.1 | 0.39 | 87 | 30 | 30 |
| ple | butoxy- | 2,4- | chlori | Propanol | Ethoxy- | acid | 10⁻⁴ | | | | | | |
| 7 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.4 × | 0.026 | 1.0 | 0.026 | 95 | 30 | 30 |
| ple | butoxy- | 2,4- | chloric | Propanol | Ethoxy- | acid | 10⁻⁴ | | | | | | |
| 8 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.2 × | 3.2 | 1.0 | 3.3 | 41 | 30 | 30 |
| ple | butoxy- | 2,4- | chloric | Propanol | Ethoxy- | acid | 10⁻⁴ | | | | | | |
| 9 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 3.2 × | 0.026 | 1.0 | 0.026 | 95 | 30 | 30 |
| ple | butoxy- | 2,4- | chloric | Propanol | Ethoxy- | acid | 10⁻⁴ | | | | | | |
| 10 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 4.5 × | 3.2 | 1.0 | 3.3 | 43 | 30 | 30 |
| ple | butoxy- | 2,4- | chloric | Propanol | Ethoxy- | acid | 10⁻⁵ | | | | | | |
| 11 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 10 | 30 |
| ple | butoxy- | 2,4- | chloric | Propanol | Ethoxy- | acid | 10⁻⁴ | | | | | | |
| 12 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 30 | 3 |
| ple | butoxy- | 2,4- | chloric | Propanol | Ethoxy- | acid | 10⁻⁴ | | | | | | |
| 13 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.3 × | 0.052 | 1.1 | 0.055 | 88 | 30 | 90 |
| ple | butoxy- | 2,4- | chloric | Propanol | Ethoxy- | acid | 10⁻⁴ | | | | | | |
| 14 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.2 × | 0.034 | 1.0 | 0.035 | 96 | 30 | 30 |
| ple | butoxy- | 2,4- | chloric | Propano | Ethoxy- | acid | 10⁻⁴ | | | | | | |
| 15 | zirconium | pentane- | acid | 1 | 2- | | | | | | | | |
| | | dione | | | propanol | | | | | | | | |
| Exa | Tetra-n- | 3-Methyl- | Hydro- | 2- | 1- | Acetic | 1.2 × | 2.6 | 1.0 | 2.7 | 32 | 30 | 30 |
| ple | butoxy- | 2,4- | chloric | Propano | Ethoxy- | acid | 10⁻⁴ | | | | | | |
| 16 | zirconium | pentane- | acid | 1 | 2- | | | | | | | | |
| | | dione | | | propanol | | | | | | | | |
| Exam- | Tetra-n- | 3-Methyl- | Hydro- | 2- | 1- | Acetic | 1.2 × | 3.4 × | 1.0 | 3.5 × | 96 | 30 | 30 |
| ple | butoxy- | 2,4- | chloric | Propanol | Ethoxy- | acid | 10⁻⁴ | 10⁻³ | | 10⁻³ | | | |
| 17 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.2 × | 4.4 | 1.0 | 4.6 | 28 | 30 | 30 |
| ple | butoxy- | 2,4- | chloric | Propanol | Ethoxy- | acid | 10⁻⁴ | | | | | | |
| 18 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 4.8 × | 3.4 × | 1.0 | 3.5 × | 96 | 30 | 30 |
| ple | butoxy- | 2,4- | chloric | Propanol | Ethoxy- | acid | 10⁻⁴ | 10⁻³ | | 10⁻³ | | | |
| 19 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 2.9 × | 4.4 | 1.0 | 4.6 | 29 | 30 | 30 |
| ple | butoxy- | 2,4- | chloric | Propanol | Ethoxy- | acid | 10⁻⁵ | | | | | | |
| 20 | zirconium | pentane- | acid | | 2- | | | | | | | | |
| | | dione | | | propanol | | | | | | | | |
| Exam- | Tetra-n- | 3-Methyl- | Hydro- | 2- | 1- | Formic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 21 | zirconium | pentane- | acid | | 2- | | | | | | | | |
| | | dione | | | propanol | | | | | | | | |
| Exam- | Tetra-n- | 3-Methyl- | Hydro- | 2- | 1- | Lactic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 22 | zirconium | pentane- | acid | | 2- | | | | | | | | |
| | | dione | | | propanol | | | | | | | | |
| Exam- | Tetra-n- | 3-Methyl- | Hydro- | 2- | 1- | Citric | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 23 | zirconium | pentane- | acid | | 2- | | | | | | | | |
| | | dione | | | propanol | | | | | | | | |
| Exam- | Tetra-n- | 3-Methyl- | Hydro- | 2- | 1- | Malic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 24 | zirconium | pentane- | acid | | 2- | | | | | | | | |
| | | dione | | | propanol | | | | | | | | |
| Exam- | Tetra-n- | 3-Methyl- | Hydro- | 2- | 1- | Succinic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 25 | zirconium | pentane- | acid | | 2- | | | | | | | | |
| | | dione | | | propanol | | | | | | | | |

TABLE 2

| | | | | | | Organic acid addition step | | | | | | | |
|---|---|---|---|---|---|---|---|---|---|---|---|---|---|
| | | | | | | | | | | | Content | | |
| | | | | | | | | | | | [%] of | | |
| | Condensation step | | | | | | | | | | water- | Heat treatment | |
| | | α-Substi- | Inor- | | | | | | | | soluble | | Time |
| | Metal | tuted | ganic | Solvent | Solvent | Organ- | | | | | organic | Tempera- | period |
| | alkoxide | β-diketone | acid | 1 | 2 | ic acid | b/a | c/a | a/d | c/d | solvent | ture [° C.] | [min] |
| Exam- | Tetra- | 3-Methyl- | Hydro- | 2- | 1- | Acetic | 1.2 × | 0.033 | 1.0 | 0.034 | 89 | 30 | 30 |
| ple | methoxy- | 2,4- | chloric | Propanol | Ethoxy- | acid | 10⁻⁴ | | | | | | |
| 26 | zirconium | pentane- | acid | | 2- | | | | | | | | |
| | | dione | | | propanol | | | | | | | | |
| Exam- | Tetra- | 3-Methyl- | Hydro- | 2- | 1- | Acetic | 1.2 × | 0.039 | 1.0 | 0.041 | 89 | 30 | 30 |
| ple | ethoxy- | 2,4- | chloric | Propanol | Ethoxy- | acid | 10⁻⁴ | | | | | | |
| 27 | zirconium | pentane- | acid | | 2- | | | | | | | | |
| | | dione | | | propanol | | | | | | | | |
| Exam- | Tetra-n- | 3-Methyl- | Hydro- | 2- | 1- | Acetic | 1.1 × | 0.046 | 1.1 | 0.048 | 89 | 30 | 30 |
| ple | propoxy- | 2,4- | chloric | Propanol | Ethoxy- | acid | 10⁻⁴ | | | | | | |
| 28 | zirconium | pentane- | acid | | 2- | | | | | | | | |
| | | dione | | | propanol | | | | | | | | |
| Exam- | Tetra-i- | 3-Methyl- | Hydro- | 2- | 1- | Acetic | 1.1 × | 0.046 | 1.0 | 0.046 | 89 | 30 | 30 |
| ple | propoxy- | 2,4- | chloric | Propanol | Ethoxy- | acid | 10⁻⁴ | | | | | | |
| 29 | zirconium | pentane- | acid | | 2- | | | | | | | | |
| | | dione | | | propanol | | | | | | | | |
| Exam- | Tetra-i- | 3-Methyl- | Hydro- | 2- | 1- | Acetic | 1.2 × | 0.052 | 1.1 | 0.055 | 89 | 30 | 30 |
| ple | butoxy- | 2,4- | chloric | Propanol | Ethoxy- | acid | 10⁻⁴ | | | | | | |
| 30 | zirconium | pentane- | acid | | 2- | | | | | | | | |
| | | dione | | | propanol | | | | | | | | |
| Exam- | Tri-sec- | 3-Methyl- | Hydro- | 2- | 1- | Acetic | 2.9 × | 0.12 | 0.30 | 0.037 | 89 | 30 | 30 |
| ple | butoxy- | 2,4- | chloric | Propanol | Ethoxy- | acid | 10⁻⁴ | | | | | | |
| 31 | aluminum | pentane- | acid | | 2- | | | | | | | | |
| | | dione | | | propanol | | | | | | | | |
| Exam- | Penta-n- | 3-Methyl- | Hydro- | 2- | 1- | Acetic | 1.1 × | 0.059 | 1.1 | 0.064 | 89 | 30 | 30 |
| ple | butoxy- | 2,4- | chloric | Propanol | Ethoxy- | acid | 10⁻⁴ | | | | | | |
| 32 | niobium | pentane- | acid | | 2- | | | | | | | | |
| | | dione | | | propanol | | | | | | | | |
| Exam- | Tungsten | 3-Methyl- | Hydro- | 2- | 1- | Acetic | 6.1 × | 1.6 | 0.26 | 0.41 | 75 | 30 | 30 |
| ple | (V) | 2,4- | chloric | Propanol | Ethoxy- | acid | 10⁻⁵ | | | | | | |
| 33 | ethoxide | pentane- | acid | | 2- | | | | | | | | |
| | | dione | | | propanol | | | | | | | | |
| Exam- | Penta- | 3-Methyl- | Hydro- | 2- | 1- | Acetic | 6.1 × | 1.6 | 0.26 | 0.41 | 76 | 30 | 30 |
| ple | ethoxy- | 2,4- | chloric | Propanol | Ethoxy- | acid | 10⁻⁵ | | | | | | |
| 34 | tantalum | pentane- | acid | | 2- | | | | | | | | |
| | | dione | | | propanol | | | | | | | | |
| Exam- | Penta- | 3-Methyl- | Hydro- | 2- | 1- | Acetic | 6.1 × | 1.6 | 0.26 | 0.41 | 76 | 30 | 30 |
| ple | ethoxy- | 2,4- | chloric | Propanol | Ethoxy- | acid | 10⁻⁵ | | | | | | |
| 35 | tantalum | pentane- | acid | | 2- | | | | | | | | |
| | | dione | | | propanol | | | | | | | | |
| Exam- | Tetra-n- | 3,5- | Hydro- | 2- | 1- | Acetic | 1.3 × | 0.054 | 0.84 | 0.046 | 88 | 30 | 30 |
| ple | butoxy- | Dimethyl- | chloric | Propanol | Ethoxy- | acid | 10⁻⁴ | | | | | | |
| 36 | zirconium | 2,4- | acid | | 2- | | | | | | | | |
| | | pentane- | | | propanol | | | | | | | | |
| | | dione | | | | | | | | | | | |

TABLE 3

| | | | | Content | | |
|---|---|---|---|---|---|---|
| | | | | [%] of | | |
| Condensation step | | | | water- | Heat treatment | |
| | α-Substi- | Inor- | Organic acid addition step | soluble | | Time |

| | Metal | tuted | ganic | Solvent | Solvent | Organic | | | | | organic | Tempera- | period |
|---|---|---|---|---|---|---|---|---|---|---|---|---|---|
| | alkoxide | β-diketone | acid | 1 | 2 | acid | b/a | c/a | a/d | c/d | solvent | ture [° C.] | [min] |
| Exam- | Tetra-n- | 3-Methyl- | Sulfuric | 2- | 1- | Acetic | 1.7 × | 0.052 | 1.1 | 0.055 | 88 | 30 | 30 |
| ple | butoxy- | 2,4- | acid | Propanol | Ethoxy- | acid | 10⁻⁴ | | | | | | |
| 37 | zirconium | pentane- | | | 2- | | | | | | | | |
| | | dione | | | propanol | | | | | | | | |
| Exam- | Tetra-n- | 3-Methyl- | Nitric | 2- | 1- | Acetic | 2.2 × | 0.052 | 1.1 | 0.055 | 88 | 30 | 30 |
| ple | butoxy- | 2,4- | acid | Propanol | Ethoxy- | acid | 10⁻⁴ | | | | | | |
| 38 | zirconium | pentane- | | | 2- | | | | | | | | |
| | | dione | | | propanol | | | | | | | | |
| Exam- | Tetra-n- | 3-Methyl- | Phos- | 2- | 1- | Acetic | 1.1 × | 0.052 | 1.1 | 0.055 | 88 | 30 | 30 |
| ple | butoxy- | 2,4- | phoric | Propanol | Ethoxy- | acid | 10⁻⁴ | | | | | | |
| 39 | zirconium | pentane- | acid | | 2- | | | | | | | | |
| | | dione | | | propanol | | | | | | | | |
| Exam- | Tetra-n- | 3-Methyl- | Hydro- | Methanol | 1- | Acetic | 1.3 × | 0.052 | 1.1 | 0.055 | 88 | 30 | 30 |
| ple | butoxy- | 2,4- | chloric | | Ethoxy- | acid | 10⁻⁴ | | | | | | |
| 40 | zirconium | pentane- | acid | | 2- | | | | | | | | |
| | | dione | | | propanol | | | | | | | | |
| Exam- | Tetra-n- | 3-Methyl- | Hydro- | Ethanol | 1- | Acetic | 1.3 × | 0.052 | 1.1 | 0.055 | 88 | 30 | 30 |
| ple | butoxy- | 2,4- | chloric | | Ethoxy- | acid | 10⁻⁴ | | | | | | |
| 41 | zirconium | pentane- | acid | | 2- | | | | | | | | |
| | | dione | | | propanol | | | | | | | | |
| Exam- | Tetra-n- | 3-Methyl- | Hydro- | 1- | 1- | Acetic | 1.3 × | 0.052 | 1.1 | 0.055 | 88 | 30 | 30 |
| ple | butoxy- | 2,4- | chloric | Propanol | Ethoxy- | acid | 10⁻⁴ | | | | | | |
| 42 | zirconium | pentane- | acid | | 2- | | | | | | | | |
| | | dione | | | propanol | | | | | | | | |
| Exam- | Tetra-n- | 3-Methyl- | Hydro- | Ethyl | 1- | Acetic | 1.3 × | 0.052 | 1.1 | 0.055 | 88 | 100 | 30 |
| ple | butoxy- | 2,4- | chloric | cello- | Ethoxy- | acid | 10⁻⁴ | | | | | | |
| 43 | zirconium | pentane- | acid | solve | 2- | | | | | | | | |
| | | dione | | | propanol | | | | | | | | |
| Exam- | Tetra-n- | 3-Methyl- | Hydro- | Butyl | 1- | Acetic | 1.3 × | 0.052 | 1.1 | 0.055 | 88 | 120 | 30 |
| ple | butoxy- | 2,4- | chloric | carbitol | Ethoxy- | acid | 10⁻⁴ | | | | | | |
| 44 | zirconium | pentane- | acid | | 2- | | | | | | | | |
| | | dione | | | propanol | | | | | | | | |
| Com- | Tetra-n- | — | Hydro- | 2- | 1- | — | 1.3 × | — | — | — | 90 | — | — |
| para- | butoxy- | | chloric | Propanol | Ethoxy- | | 10⁻⁴ | | | | | | |
| tive | zirconium | | acid | | 2- | | | | | | | | |
| Exam- | | | | | propanol | | | | | | | | |
| ple | | | | | | | | | | | | | |
| 1 | | | | | | | | | | | | | |
| Com- | Tetra-n- | 3-Methyl- | Hydro- | 2-Ethyl- | 2-Ethyl- | Acetic | 1.3 × | 0.052 | 1.1 | 0.055 | 0 | 30 | 30 |
| para- | butoxy- | 2,4- | chloric | 1- | 1- | acid | 10⁻⁴ | | | | | | |
| tive | zirconium | pentane- | acid | butanol | butanol | | | | | | | | |
| Exam- | | dione | | | | | | | | | | | |
| ple | | | | | | | | | | | | | |
| 2 | | | | | | | | | | | | | |
| Com- | Tetra-n- | 3-Methyl- | Hydro- | 2- | 1- | — | 1.3 × | — | 1.1 | — | 88 | — | — |
| para- | butoxy- | 2,4- | chloric | Propanol | Ethoxy- | | 10⁻⁴ | | | | | | |
| tive | zirconium | pentane- | acid | | 2- | | | | | | | | |
| Exam- | | dione | | | propanol | | | | | | | | |
| ple | | | | | | | | | | | | | |
| 3 | | | | | | | | | | | | | |
| Com- | Tetra-n- | 3-Methyl- | Hydro- | 2- | 1- | Sulfuric | 1.3 × | 0.052 | 1.1 | 0.055 | 88 | 30 | 30 |
| para- | butoxy- | 2,4- | chloric | Propanol | Ethoxy- | acid | 10⁻⁴ | | | | | | |
| tive | zirconium | pentane- | acid | | 2- | | | | | | | | |
| Exam- | | dione | | | propanol | | | | | | | | |
| ple | | | | | | | | | | | | | |
| 4 | | | | | | | | | | | | | |

TABLE 4

| | | Water addition | | | | |
|---|---|---|---|---|---|---|
| | Median | Addition | | | Film-forming property | |
| | diameter | amount | | Dispers- | Sol | Mixed |
| | [nm] | [part(s)] | pH | ibility | liquid | liquid |
| Example 1 | 1.8 | 1 | 5.81 | A | A | A |
| Example 2 | 1.5 | 1 | 5.68 | A | A | A |
| Example 3 | 5.7 | 1 | 6.11 | B | A | A |
| Example 4 | 1.3 | 1 | 5.56 | A | A | A |
| Example 5 | 13.0 | 1 | 6.34 | B | A | A |
| Example 6 | 1.8 | 1/9 | 6.25 | A | A | A |
| Example 7 | 1.7 | 9 | 4.57 | A | A | B |
| Example 8 | 1.5 | 1 | 6.02 | B | B | A |
| Example 9 | 3.2 | 1 | 2.10 | A | A | A |
| Example 10 | 17.0 | 1 | 5.52 | B | A | A |
| Example 11 | 2.7 | 1 | 1.98 | B | A | A |
| Example 12 | 1.1 | 1 | 5.52 | B | A | A |
| Example 13 | 1.2 | 1 | 5.62 | B | A | A |
| Example 14 | 3.8 | 1 | 6.27 | C | A | A |
| Example 15 | 1.1 | 1 | 6.09 | A | B | B |
| Example 16 | 9.2 | 1 | 2.01 | C | A | A |
| Example 17 | 1.4 | 1 | 6.17 | B | B | B |
| Example 18 | 4.5 | 1 | 1.56 | C | A | A |
| Example 19 | 28.0 | 1 | 6.08 | C | B | B |
| Example 20 | 3.5 | 1 | 1.43 | C | A | A |
| Example 21 | 1.6 | 1 | 6.24 | B | A | A |
| Example 22 | 1.4 | 1 | 5.92 | B | A | A |
| Example 23 | 2.4 | 1 | 5.83 | C | B | B |
| Example 24 | 3.2 | 1 | 5.64 | B | A | B |
| Example 25 | 3.7 | 1 | 5.72 | C | B | B |

TABLE 5

| | | Water addition | | | Film-forming | |
|---|---|---|---|---|---|---|
| | Median | Addition | | | property | |
| | diameter | amount | | Dispersi- | Sol | Mixed |
| | [nm] | [part(s)] | pH | ibility | liquid | liquid |
| Example 26 | 4.2 | 1 | 5.78 | B | A | A |
| Example 27 | 3.3 | 1 | 5.92 | B | A | A |
| Example 28 | 2.5 | 1 | 6.02 | A | A | A |
| Example 29 | 1.9 | 1 | 6.10 | A | A | A |
| Example 30 | 1.5 | 1 | 5.85 | A | A | A |
| Example 31 | 3.2 | 1 | 5.74 | B | A | A |
| Example 32 | 17 | 1 | 6.09 | C | A | B |
| Example 33 | 26 | 1 | 3.13 | C | A | B |
| Example 34 | 2.8 | 1 | 3.03 | A | A | A |
| Example 35 | 2.4 | 1 | 2.92 | B | A | B |
| Example 36 | 86.0 | 1 | 5.92 | C | B | B |
| Example 37 | 44.0 | 1 | 5.73 | B | B | B |
| Example 38 | 39.0 | 1 | 5.81 | B | A | A |
| Example 39 | 53.0 | 1 | 5.92 | C | B | B |
| Example 40 | 0.9 | 1 | 6.11 | B | A | A |
| Example 41 | 1.2 | 1 | 6.06 | B | A | A |
| Example 42 | 1.9 | 1 | 6.15 | B | A | A |
| Example 43 | 35.0 | 1 | 6.54 | C | A | B |
| Example 44 | 97.0 | 1 | 6.81 | C | B | B |
| Comparative | -(Precipi- | — | — | — | C | -(Gela- |
| Example 1 | tation) | | | | | tion) |
| Comparative | 2.6 | 1 | — | D | A | -(Gela- |
| Example 2 | | | | | | tion) |
| Comparative | 2.2 | 1 | — | D | A | -(Gela- |
| Example 3 | | | | | | tion) |
| Comparative | 2.0 | 1 | 4.76 | C | B | C |
| Example 4 | | | | | | |

As apparent from the evaluation results shown in Tables 4 and 5, in the sol liquid of each of Examples 1 to 44, the particle diameter of the particulate incomplete condensate was small, and hence the sol liquid was excellent in dispersion stability. In addition, the sol liquid of each of Examples 1 to 44 can be mixed with an aqueous sol liquid at any ratio, and hence a coating film excellent in applicability and uniformity was able to be formed.

Even a uniform composite inorganic oxide film having a good coating property can be provided by using the sol liquid of the present invention in combination with various existing aqueous sol liquids.

According to the present invention, even when the sol liquid contains water, the dispersion stability is excellent. Accordingly, the sol liquid, which can be mixed with various aqueous sol liquids at any ratio, and can easily produce even a film of a composite inorganic oxide on each of various base materials through an application process, can be provided. In addition, according to the present invention, the coating film excellent in applicability and uniformity can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2022-104842, filed Jun. 29, 2022 and No. 2023-074623 filed Apr. 28, 2023, which are hereby incorporated by reference herein in their entirety.

What is claimed is:

1. A sol liquid comprising:
a metal alkoxide condensate;
an α-substituted β-diketone; and
a water-soluble organic solvent,
the sol liquid further comprising an inorganic acid and an organic acid.

2. The sol liquid according to claim 1, wherein the organic acid is an organic acid having one or more carboxyl groups and having 6 or less carbon atoms.

3. The sol liquid according to claim 2, wherein the organic acid comprises at least one kind selected from the group consisting of: acetic acid; formic acid; citric acid; malic acid; lactic acid; succinic acid; propionic acid; glycolic acid; malonic acid; glutaric acid; and tartaric acid.

4. The sol liquid according to claim 1, wherein the inorganic acid comprises at least one kind selected from the group consisting of: hydrochloric acid; sulfuric acid; nitric acid; and phosphoric acid.

5. The sol liquid according to claim 1, wherein a metal element content of the metal alkoxide condensate and a content of the inorganic acid satisfy a relationship of the following formula (1):
4.0×10⁻⁵≤b/a≤3.5×10⁻⁴ (1)
where:
“a” represents a metal element content [mass %] of the metal alkoxide condensate with respect to a total amount of the sol liquid; and
“b” represents a content [mass %] of the inorganic acid with respect to the total amount of the sol liquid.

6. The sol liquid according to claim 1, wherein a metal element content of the metal alkoxide condensate and a content of the organic acid satisfy relationships of the following formula (2) and the following formula (3):
0.020≤c≤20 (2)
0.025≤c/a≤3.3 (3)
where:
“a” represents a metal element content [mass %] of the metal alkoxide condensate with respect to a total amount of the sol liquid; and
“c” represents a content [mass %] of the organic acid with respect to the total amount of the sol liquid.

7. The sol liquid according to claim 1, wherein the water-soluble organic solvent comprises at least one kind selected from the group consisting of: an alcohol-based solvent; a glycol-based solvent; a glycol ether-based solvent; an ether-based solvent; and a ketone-based solvent.

8. The sol liquid according to claim 1, wherein the water-soluble organic solvent is incorporated at 40 mass % or more with respect to a total amount of the sol liquid.

9. The sol liquid according to claim 1, wherein the α-substituted β-diketone is 3-methyl-2,4-pentanedione.

10. The sol liquid according to claim 1, wherein the metal alkoxide condensate has a median diameter of 1 nm or more and 100 nm or less.

11. A mixed liquid comprising:
a sol liquid containing a metal alkoxide condensate, an α-substituted β-diketone, and a water-soluble organic solvent, the sol liquid further containing an inorganic acid and an organic acid; and
water,
the mixed liquid having a pH of 2.00 or more and 7.00 or less.

12. The mixed liquid according to claim 11,
wherein the metal alkoxide condensate in the sol liquid contains a first metal element, and
wherein the mixed liquid further comprises a metal alkoxide condensate containing a second metal element different from the first metal element.

13. A coating film, which is obtained by heating one of:
a sol liquid comprising a metal alkoxide condensate, an α-substituted β-diketone, and a water-soluble organic solvent, the sol liquid further comprising an inorganic acid and an organic acid; or
a mixed liquid comprising: a sol liquid containing a metal alkoxide condensate, an α-substituted β-diketone, and a water-soluble organic solvent, the sol liquid further containing an inorganic acid and an organic acid; and water, the mixed liquid having a pH of 2.00 or more and 7.00 or less.

14. A method of producing a sol liquid comprising:
a condensation step of subjecting a metal alkoxide to condensation by adding an inorganic acid to a reaction liquid obtained by mixing the metal alkoxide and an α-substituted β-diketone with a water-soluble organic solvent; and
an organic acid addition step of adding an organic acid to the reaction liquid after the condensation step.

15. The method of producing a sol liquid according to claim 14, wherein the organic acid addition step includes performing heat treatment by heating at 20° C. or more and 100° C. or less for 5 minutes or more and 1 hour or less after the adding an organic acid.

16. A method of producing a coating film, comprising in the following order:
an application step of applying, onto a base material, one of:
a sol liquid containing a metal alkoxide condensate, an α-substituted β-diketone, and a water-soluble organic solvent, the sol liquid further comprising an inorganic acid and an organic acid; or
a mixed liquid including: a sol liquid containing a metal alkoxide condensate, an α-substituted β-diketone, and a water-soluble organic solvent, the sol liquid further containing an inorganic acid and an organic acid; and water, the mixed liquid having a pH of 2.00 or more and 7.00 or less; and
a heating step of heating the base material at a temperature equal to or less than a glass transition temperature of the base material.
